(19) United States
(12) Patent Application Publication
(10) Pub. No.: US 2003/0224129 A1
(43) Pub. Date: Dec. 4, 2003

(54) Ink-jet recording material

(76) Inventors: Norimasa Miyachi, Chiyoda-ku (JP); Yukio Tokunaga, Chiyoda-ku (JP); Syuzo Kinoshita, Chiyoda-ku (JP)

Correspondence Address: MANELLI DENISON & SELTER, 2000 M STREET NW SUITE 700, WASHINGTON, DC, 20036-3307, US

(21) Appl. No.: 10/446,691

(22) Filed: May 29, 2003

(30) Foreign Application Priority Data
May 31, 2002 (JP) 2002-159305
Feb. 26, 2003 (JP) 2003-48639

(51) Int. Cl. B32B 3/00

(52) U.S. Cl. 428/32.1; 428/32.34

(57) ABSTRACT

There is disclosed an ink-jet recording material which comprises a support, at least one ink-receptive layer mainly containing cationized anionic inorganic particles and a layer mainly containing colloidal silica both of which are provided on the support in this order, wherein the colloidal silica-containing layer contains cationic colloidal silica or a cationic compound.

### BACKGROUND OF THE INVENTION

1. Field of the Invention

The present invention relates to an ink-jet recording material, more specifically to an ink-jet recording material excellent in glossiness, an ink-absorption property and flaw resistance.

2. Prior art

As a recording material to be used for an ink-jet recording system, a recording material in which a porous ink-receptive layer comprising a pigment such as amorphous silica and a hydrophilic binder such as polyvinyl alcohol is provided on a usual paper support has been known.

For example, it has been proposed a recording material in which a silicon-containing pigment such as silica is provided on a paper support with a hydrophilic binder, as disclosed in Japanese Provisional Patent Publications No. 51583/1980, No. 157/1981, No. 107879/1982, No. 107880/1982, No. 230787/1984, No. 160277/1987, No. 184879/1987, No. 183382/1987, No. 11877/1989, and the like.

Also, in Japanese Patent Publication No. 56552/1991, Japanese Provisional Patent Publications No. 188287/1990, No. 81064/1998, No. 119423/1998, No. 175365/1998, No. 193776/1998, No. 203006/1998, No. 217601/1998, No. 20300/1999, No. 20306/1999 and No. 34481/1999, U.S. Pat. No. 5,612,281, and EP 0 813 978A, and the like, there have been disclosed ink-jet recording materials using synthetic silica fine particles prepared by a gas phase process (hereinafter referred to as “fumed silica”). Also, in Japanese Provisional Patent Publications No. 321079/1999, and No. 2001-80204, there are disclosed that a slurry in which fumed silica is dispersed in the presence of a cationic compound is used.

In Japanese Provisional Patent Publications No. 286165/1997, and No. 181190/1998, there are disclosed that silica fine particles in which precipitation method silica is pulverized by a mechanical means are used.

The above-mentioned fumed silica or pulverized silica fine particles have a smaller particle size, so that they have characteristics that high glossiness and high ink-absorption property can be obtained. On the other hand, due to its smaller particle size, there are problems that flaw is likely generated at the surface of an ink-receptive layer and the flaw is more conspicuous.

On the other hand, as a support for an ink-jet recording material, paper has been generally used, and paper itself had a role of an ink-absorption layer. In recent years, a photo-like recording sheet has been desired, and in a recording sheet using a paper support, there are problems in glossiness, feeling of quality, water-resistance, cockling after printing (crease or waving) and the like, so that a paper support subjected to water-proof treatment, for example, a resin laminated paper in which a polyolefin resin such as polyethylene, etc. is laminated on the both surfaces of paper (a polyolefin resin-coated paper), a plastic film, etc. have been used. However, an ink-jet recording material using such a water-resistant support has higher smoothness than the ink-jet recording material using a paper support, so that there is a problem that flaw is likely generated on the surface of the ink-receptive layer due to rubbing with a back surface. Also, a water-resistant support itself has no ink-absorption property, so that an ink-absorption capacity of the ink-receptive layer must be large. For this purpose, it is necessary to make a void volume of the ink-receptive layer higher and to coat the ink-receptive layer with thicker thickness. To make the void volume higher, it is necessary to make a ratio of an organic binder to the inorganic fine particles smaller. However, due to decreased amount of the organic binder, a film of the ink-receptive layer is weak or fragile, and flaw is much easily generated. This phenomenon is particularly remarkable when fine particles containing aggregated particles having an average particle size of 500 nm or less are used.

As a technique to solve the above-mentioned problems, it has been proposed to provide a layer containing colloidal silica at an upper layer. For example, it has been proposed in Japanese Provisional Patent Publications No. 183131/1994, No. 183134/199.4, No. 101142/1995, No. 183267/1997, No. 71762/1998, No. 166715/1998, No. 2000-33769, No. 2000-37944, No. 2000-108505, No. 2000-280609, No. 2001-10212, No. 2001-353957, etc. However, glossiness, an ink-absorption property, flaw resistance and further uniformly coated surface cannot be realized simultaneously and sufficiently by simply providing a colloidal silica-containing layer as an upper layer.

Also, as can be seen from the above-mentioned Japanese Provisional Patent Publications, as a conventional and general preparation method of an ink-jet recording material, there has been employed a stepwise coating method in which an ink-receptive layer is coated as an under layer and dried, and then, a colloidal silica-containing layer is coated as an upper layer and dried. To heighten an ink-absorption property which is one of the objects of the present invention, the inventors have confirmed that a combination of an ink-receptive layer having a relatively thicker thickness and a colloidal silica-containing layer having a relatively thinner thickness is preferred. In case of such a constitution, it can be revealed that sufficient glossiness and flaw resistance cannot be obtained by the above-mentioned conventional preparation method, i.e., a method of coating and drying a colloidal silica-containing layer on a previously coated and dried ink-receptive layer. Also, in the stepwise coating method in which a relatively thinner thickness colloidal silica-containing layer is coated on an ink-receptive layer, there is a problem that a uniform coating surface can be difficultly obtained. Also, even when an ink-receptive layer and a colloidal silica-containing layer are provided by a simultaneous multilayer coating in place of the above-mentioned stepwise coating, a uniform coated surface cannot be obtained, and sufficient glossiness and ink-absorption property cannot be obtained.

In general, silica fine particles to be used in an ink-receptive layer have been used as a dispersion in which the silica fine particles are dispersed by using a high speed homomixer, a high pressure dispersing device, an ultrasonic dispersing device, a ball mill, etc. In this case, it is generally employed a method in which the silica fine particles are dispersed in a dispersing medium mainly comprising water. It is also the same in a dispersion of fumed silica. A conventional and general preparation method of a coating solution for an ink-receptive layer is to mix the silica fine particles dispersed as mentioned above with a hydrophilic binder such as polyvinyl alcohol, a cationic polymer, a surfactant, a cross-linking agent, etc., and to disperse the resulting mixture again by a dispersing device, if necessary. In an ink-jet recording material obtained by laminating a coating solution for an ink-receptive layer and a coating solution for a colloidal silica-containing layer thus prepared, a material which sufficiently satisfies all of flaw resistance, glossiness, an ink-absorption property and a uniformly coated surface cannot be obtained irrespective of a coating system or method.

### SUMMARY OF THE INVENTION

Accordingly, an object of the present invention is to provide an ink-jet recording material which is excellent in glossiness, an ink-absorption property and flaw resistance, and having a uniformly coated surface. The above-mentioned objects of the present invention can be accomplished by an ink-jet recording material which comprises a support, at least one ink-receptive layer mainly containing cationized anionic inorganic fine particles and a layer mainly containing colloidal silica both of which are provided on the support in this order, wherein the colloidal silica-containing layer contains cationic colloidal silica or a cationic compound.

### DESCRIPTION OF THE PREFERRED EMBODIMENTS

In the following, the present invention will be explained in detail.

The ink-jet recording material of the present invention has at least one ink-receptive layer mainly containing cationized anionic inorganic fine particles. Here, the terms “mainly containing inorganic fine particles” mean that the inorganic fine particles are contained in the ink-receptive layer in an amount of 50% by weight or more, more preferably 60% by weight or more, particularly preferably 6.5% by weight or more based on the total solid content of the ink-receptive layer, and the upper limit thereof is 95% by weight or so. Also, a coated amount of the inorganic fine particles in the ink-receptive layer is preferably in the range of 8 to 40 g/m², more preferably 10 to 35 g/m², particularly preferably 15 to 30 g/m².

The anionic inorganic fine particles to be used in the present invention are inorganic fine particles the surface of which are anionic, and there may be mentioned, for example, titanium oxide, zinc oxide, calcium carbonate, synthetic silica, etc. The term “cationized” mentioned in the present specification means that the inorganic fine particles having an anionic surface are changed to inorganic fine particles having a cationic surface.

As the anionic inorganic fine particles to be used in the present invention, synthetic silica is preferably used. The synthetic silica can be roughly classified into fumed silica and wet process silica according to the preparation processes thereof.

Fumed silica is also called to as the drying method silica, and it can be generally prepared by a flame hydrolysis method. More specifically, it has generally been known a method in which silicon tetrachloride is burned with hydrogen and oxygen, and a silane such as methyl trichlorosilane or trichlorosilane may be used in place of silicon tetrachloride singly or in combination with silicon tetrachloride. The fumed silica is commercially available from Nippon Aerosil K.K. (Japan) under the trade name of Aerosil, and K.K. Tokuyama (Japan) under the trade name of QS type, etc.

The wet method silica can be further classified into a precipitated method silica, a gel method silica and a sol method silica according to the preparation process. The precipitated silica can be prepared by reacting sodium silicate and sulfuric acid under alkali conditions. Silica particles grown in particle size aggregated and precipitated, and then, they are processed through filtration, washing, drying, pulverization and classification to obtain a product. The silica secondary particles prepared by this method become gently aggregated particles, and relatively easily pulverizing particles can be obtained. As the precipitated silica, it is commercially available from Nippon Silica Industrial Co., Ltd. under tradename of Nipsil, K.K. Tokuyama under tradenames of Tokusil, Finesil and the like.

The gel method silica can be produced by reacting sodium silicate and sulfuric acid under acidic conditions. In this method, small silica particles are dissolved during ripening and so reprecipitated between primary particles which are large sized particles that primary particles are combined to each other. Thus, clear primary particles disappear and form relatively hard agglomerated particles having inner void structure. For example, it is comercially available from Mizusawa Industrial Chemicals, Ltd. under tradename of Mizukasil, Grace Japan Co., Ltd. under tradename of Cyrojet, and the like.

The sol method silica is also called to as colloidal silica and can be obtained by heating and ripening silica sol obtained by methathesis of sodium silicate by an acid or passing through an ion-exchange resin layer, and is commercially available from Nissan Chemical Industries, Ltd. under tradename of SNOWTEX. In the present invention, this colloidal silica cannot be used as inorganic fine particles of the ink-receptive layer but used in the colloidal silica-containing layer provided on the ink-receptive layer.

Preferred synthetic silica of the anionic inorganic fine particles to be used in the ink-receptive layer of the present invention is the fumed silica, the precipitation method silica or the gel method silica as mentioned above.

Next, a cationization treatment of the above-mentioned anionic inorganic fine particles is explained. First, a cationization treatment of the fumed silica is explained. The fumed silica can be cationized by dispersing it in the presence of a cationic compound.

The dispersing step of the fumed silica comprises a first dispersing step of adding the fumed silica to a dispersing medium and mixing (pre-dispersion) and a second dispersing step of dispersing a crude dispersion obtained by the first dispersing step by a dispersing device.

The pre-dispersion in the first dispersing step can be carried out by using a usual propeller stirrer, a saw blade type dispersing machine, a turbin type stirrer, a homomixer type stirrer, an ultrasonic wave stirrer, etc. As the dispersing device to be used in the second dispersing step, there may be used, for example, a pressure type dispersing device such as a high-pressure homogenizer, an ultra high-pressure homogenizer, etc., an ultrasonic wave dispersing device, a ball mill, etc. In particular, as the dispersing device to be used in the second dispersing step is preferably a pressure type dispersing device such as a high-pressure homogenizer, an ultra high-pressure homogenizer, etc., and a pressure type dispersing methods as disclosed in Japanese Provisional Patent Publications No. 310416/1998, No. 2000-239536 and No. 2001-207078 can be used.

In the present invention, the terms that “the fumed silica is dispersed in the presence of a cationic compound” means that a cationic compound is present in the dispersing procedure at least at the second dispersing step. It is preferred to add the cationic compound before initiation of the second dispersing step, more preferably the cationic compound is previously added to a dispersing medium to be used at the first dispersing step. More preferably, in the first dispersing step, to a dispersing medium containing the cationic compound, the fumed silica is added in the form of powder and the mixture is mixed. As a device to mix the powder state fumed silica in the dispersing medium, a continuous transport and dissolving system can be used. By using the above-mentioned dispersing method of the fumed silica, it is possible to produce a high-concentration silica slurry having a fumed silica concentration of 18% by weight or more, and further 19% by weight or more.

The dispersing medium to be used for dispersion of the fumed silica mainly comprises water and a small amount of an organic solvent (a low boiling point solvent such as a lower alcohol including ethanol, etc., or ethyl acetate) may be contained. In the latter case, an amount of the organic solvent is preferably 20% by weight or less, more preferably 10% by weight or less based on the total amount of the dispersing medium.

In the above-mentioned dispersing step for cationizing the fumed silica, dispersing procedure is carried out in the state without containing a hydrophilic binder such as polyvinyl alcohol or a cross-linking agent (a hardener) such as boric acid, etc. After the fumed silica is cationized, a hydrophilic binder such as polyvinyl alcohol or a cross-linking agent such as boric acid, etc., may be added thereto and the mixture may be dispersed again by a high-pressure homogenizer, etc.

The fumed silica to be used in the present invention is preferably those having an average primary particle size of 5 to 50 nm. In order to obtain higher glossiness, fumed silica having an average primary particle size of 5 to 20 nm and a specific surface area measured by the BET method of 90 to 400 m²/g is preferably used. The BET method mentioned in the present invention means one of a method for measuring surface area of powder material by a gas phase adsorption method and is a method of obtaining a total surface area possessed by 1 g of a sample, i.e., a specific surface area, from an adsorption isotherm. In general, as an adsorption gas, a nitrogen gas has frequently been used, and a method of measuring an adsorption amount obtained by the change in pressure or a volume of a gas to be adsorbed has most frequently been used. Most famous equation for representing isotherm of polymolecular adsorption is a Brunauer-Emmett-Teller equation which is also called to as a BET equation and has widely been used for determining a surface area of a substance to be examined. A surface area can be obtained by measuring an adsorption amount based on the BET equation and multiplying the amount with a surface area occupied by the surface of one adsorbed molecule.

The fumed silica cationized as mentioned above is present in the state in which primary particles having a size of several nm to several tens nm are linked and secondary aggregated with a net-work structure or chain state. It is preferred that the aggregated particles are dispersed until the average particle size becomes 500 nm or less, more preferably 300 nm or less. The lower limit of the particle size is 50 nm or so. Here, an average particle size of the aggregated particles can be obtained by electron micrograph using a transmission electron microscope. More easily and simply, it can be measured as a number median size by using a particle size distribution meter with a laser scattering type (for example, LA910, trade name, manufactured by Horiba Ltd.).

Next, cationization of the wet process silica is explained. As the wet process silica herein used, they are a precipitation method silica or a gel method silica. An average particle size (average secondary particle size) of these wet process silica is generally 1 μm or more. In the present invention, these wet process silicas are pulverized until their average particle sizes become 500 nm or less. Preferably, they are pulverized until their average particle sizes become 300 nm or less. The lower limit of the particle size is 50 nm or so. During the pulverization step, the silica fine particles are cationized. A particle size of the pulverized wet process silica can be obtained by a transmission electron microscope or a laser scattering type grain size distribution meter.

The pulverizing step of the wet process silica comprises a first dispersing step of adding the silica fine particles to a dispersing medium and mixing (pre-dispersion) and a second dispersing step of pulverizing a crude dispersion obtained by the first dispersing step by a dispersing device. The pre-dispersion in the first dispersing step can be carried out by using a usual propeller stirrer, a saw blade type dispersing machine, a turbin type stirrer, a homomixer type stirrer, an ultrasonic wave stirrer, etc. As the pulverization method of the wet process silica, a wet dispersing method in which silica dispersed in a dispersing medium is mechanically pulverized can be preferably used. As the wet type dispersing device, there may be used, for example, a media mill such as a ball mill, a beads mill, a sand grinder, etc., a pressure type dispersing device such as a high-pressure homogenizer, an ultra high-pressure homogenizer, etc., an ultrasonic wave dispersing device, a thin film revolving type dispersing device, etc., and a media mill such as a beads mill, etc., is particularly preferably used in the present invention.

In the present invention, the process of pulverizing the wet process silica in the presence of a cationic compound means that the cationic compound is present at least in the pulverization step (the second dispersing step). It is preferred to add the cationic compound before initiation of the pulverization step, more preferably the cationic compound is previously added to a dispersing medium to be used at the first dispersing step. Further preferably, in the first dispersing step, to a dispersing medium containing the cationic compound, the wet process silica is added in the form of powder and the mixture is mixed. As a device to mix the powder state wet process silica in the dispersing medium, a continuous transport and dissolving system can be used.

The dispersing medium to be used for dispersion of the wet process silica mainly comprises water and a small amount of an organic solvent (a low boiling point solvent such as a lower alcohol including ethanol, etc., or ethyl acetate) may be contained. In the latter case, an amount of the organic solvent is preferably 20% by weight or less, more preferably 10% by weight or less based on the total amount of the dispersing medium.

In the above-mentioned pulverization step for cationizing the wet process silica, pulverization procedure is carried out in the state without containing a hydrophilic binder such as polyvinyl alcohol or a cross-linking agent (a hardener) such as boric acid, etc. After the wet process silica is cationized, a hydrophilic binder such as polyvinyl alcohol or a cross-linking agent such as boric acid, etc., may be added thereto and the mixture may be dispersed again by a high-pressure homogenizer, etc.

The wet process silica to be used in the present invention preferably has an average particle size (average secondary particle size) of 5 μm or more. By pulverizing silica having a relatively large particle size, it is possible to obtain a dispersion with a relatively high concentration. An upper limit of the average particle size of the wet process silica to be used in the present invention is not specifically limited, and the average particle size of the wet process silica is usually 200 μm or less.

As the wet process silica to be used in the ink-receptive layer of the present invention, a precipitation method silica is preferably used. As mentioned above, the precipitation method silica is aggregated particles in which the secondary particles are gentle, so that they are suitable for pulverization.

In the present invention, as the cationic compound to be used for cationizing the anionic inorganic fine particles, there may be used a cationic polymer, a water-soluble polyvalent metal compound or a silane coupling agent. Of these cationic compounds, a cationic polymer and a water-soluble polyvalent metal compound are particularly preferred, and a cationic polymer is especially preferred.

As the cationic polymer to be used in the present invention, there may be mentioned a water-soluble cationic polymer having a quaternary ammonium group, a phosphonium group or an acid addition compound of a primary to tertiary amine. For example, there may be mentioned polyethyleneimine, polydialkyldiallylamine, polyallylamine, alkylamine-epichlorohydrin polycondensate, a cationic polymer as disclosed in Japanese Provisional Patent Publications No. 20696/1984, No. 33176/1984, No. 33177/1984, No. 155088/1984, No. 11389/1985, No. 49990/1985, No. 83882/1985, No. 109894/1985, No. 198493/1987, No. 49478/1988, No. 115780/1988, No. 280681/1988, No. 40371/1989, No. 234268/1994, No. 125411/1995 and No. 193776/1998, WO 99/64248, etc. A weight average molecular weight (Mw) of the cationic polymers is preferably about 100,000 or less, more preferably 50,000 or less, particularly preferably 2,000 to 300,000.

Among the above-mentioned cationic polymers, a cationic polymer having a constitutional unit of a polydiallylamine derivative is particularly preferred, and specific examples of the cationic polymer are a cationic polymer having the constitutional unit having a structure represented by the following formula (1), (2), (3) or (4). These cationic polymers are commercially available under the trade names of Sharol DC902P (available from Dai-ichi Kogyo Seiyaku Co., Ltd.), Jetfix 110 (available from Satoda Kako K.K.), UNISENCE CP-101 to 103 (available from SENKA CORPORATION), PAS-H (available from Nitto Boseki Co., Ltd.) and the like.

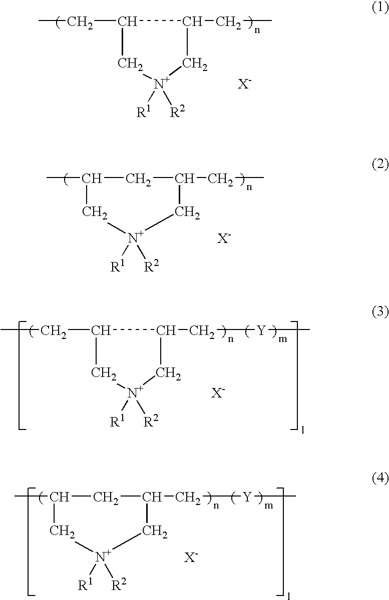

In the formulae (1), (2), (3) and (4), R¹ and R² each represent a hydrogen atom, an alkyl group such as a methyl group, an ethyl group, etc., or a substituted alkyl group such as a hydroxyethyl group, etc., and Y represents a monomer capable of being radical polymerization (for example, sulfur dioxide, acrylamide or a derivative thereof, an acrylic acid and an ester thereof, a methacrylic acid and an ester thereof). Also, in the formulae (1) and (2), n is a polymerization degree and n=5 to 10,000, and in the formulae (3) and (4), n and m each represent a molar ratio, i.e., a monomer constitution ratio, and 1 represents a polymerization degree, and satisfy n/m=9/1 to 2/8, l=5 to 10,000. X represents an anion.

Specific examples of the polydiallylamine represented by the formula (3) or (4) may include those containing SO₂ group in the recurring units as disclosed in Japanese Provisional Patent Publication No. 83882/1985, a copolymer with acrylamide as disclosed in Japanese Provisional Patent Publication No. 9776/1989 and the like.

In the present invention, an amount of the cationic polymer to be used is preferably within the range of 1 to 10% by weight based on the amount of the inorganic fine particles.

As the water-soluble polyvalent metal compound to be used in the present invention, there may be mentioned a water-soluble salt of a metal selected from the group consisting of calcium, barium, manganese, copper, cobalt, nickel, aluminum, iron, zinc, zirconium, titanium, chromium, magnesium, tungsten and molybdenum. More specifically, such a water-soluble metallic compound may include, for example, calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, copper (II) ammonium chloride dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, amide nickel sulfate tetrahydrate, aluminum sulfate, aluminum sulfite, aluminum thiosulfate, poly(aluminum chloride), aluminum nitrate nonahydrate, aluminum chloride hexahydrate, ferrous bromide, ferrous chloride, ferric chloride, ferrous sulfate, ferric sulfate, zinc bromide, zinc chloride, zinc nitrate hexahydrate, zinc sulfate, zirconium acetate, zirconium nitrate, basic zirconium carbonate, zirconium hydroxide, ammonium zirconium carbonate, potassium zirconium carbonate, zirconium sulfate, zirconium fluoride, zirconium chloride, zirconium chloride octahydrate, zirconium oxychloride, zirconium hydroxychloride, titanium chloride, titanium sulfate, chromium acetate, chromium sulfate, magnesium sulfate, magnesium chloride hexahydrate, magnesium citrate nonahydrate, sodium phosphorus wolframate, tungsten sodium citrate, dodecawolframatophosphate n hydrate, dodecawolframatosilicate 26 hydrate, molybdenum chloride, dodecamolybdatephosphate n hydrate, etc. Of these, a water-soluble salt of aluminum or an element belonging to Group IVa (Group 4) of the Periodic Table (zirconium, titanium) is particularly preferred. In the present invention, the term “water-soluble” means that a compound is soluble in water at normal temperature and normal pressure in an amount of 1% by weight or more.

As the water-soluble aluminum compound other than the above, a basic poly(aluminum hydroxide) compound is preferably used. A main component of this compound is represented by the following formula (5), (6) or (7), which is an inorganic aluminum-containing cationic polymer, and is a water-soluble poly(aluminum hydroxide) containing a polynuclear condensed ion which is basic and a polymer in a stable form, such as [Al₆(OH)₁₅] ³⁺, [Al₈ (OH)₂₀]⁴⁺, [Al₁₃(OH)₃₄] ⁵⁺, [Al₂₁(OH)₆₀] ³⁺, etc.

[Al₂(OH)ₙCl₆₋ₙ]ₘ (5)

[Al(OH)₃]ₙAlCl₃ (6)

Alₙ(OH)ₘCl₍₃ₙ₋ₘ₎ 0<m<3n (7)

These water-soluble aluminum compounds are commercially available from Taki Chemical, K.K., Japan under the trade name of poly(aluminum chloride) (PAC, trade name) as a water treatment agent, from Asada Chemical K.K., Japan under the trade name of poly(aluminum hydroxide) (Paho, trade name), from K.K. Riken Green, Japan under the trade name of Pyurakemu WT (trade name) and other manufacturers with the same objects whereby various kinds of different grades can be easily obtained. In the present invention, these commercially available products may be used as such. These basic poly(aluminum hydroxide) compounds are also disclosed in Japanese Patent Publications No. 24907/1991 and No. 42591/1991.

An amount of the above-mentioned water-soluble polyvalent metallic compound in the ink-receptive layer is preferably about 0.1 to 10% by weight based on the amount of the inorganic fine particles.

The silane coupling agent to be used in the present invention is disclosed in Japanese Provisional Patent Publication No. 2000-233572, and a cationic material can be used among these. An added amount of the silane coupling agent is preferably in the range of 0.1 to 10% by weight based on the amount of the inorganic fine particles.

In the present invention, an organic binder is preferably contained in the ink-receptive layer to maintain the characteristics as a film. As the organic binder, various kinds of water-soluble polymer or polymer latex is preferably used. As the water-soluble polymer, there may be mentioned, for example, polyvinyl alcohol, polyethylene glycol, starch, dextrin, carboxymethyl cellulose, polyvinylpyrrolidone, polyacrylic acid ester or a derivative thereof, and particularly preferable orgnanic binder is a completely or partially saponified polyvinyl alcohol or a cation-modified polyvinyl alcohol.

Of the polyvinyl alcohols, particularly preferred is a completely or partially saponified polyvinyl alcohol with a saponification degree of 80% or more and a polyvinyl alcohol having an average polymerization degree of 500 to 5,000 is preferred. Also, as the cation-modified polyvinyl alcohol, there may be mentioned a polyvinyl alcohol having a primary to tertiary amino group or a quaternary ammonium group at a main chain or a side chain of the polyvinyl alcohol, as disclosed in, for example, Japanese Provisional Patent Publication No. 10483/1986.

Also, as a polymer latex to be used as an organic binder, there may be mentioned, for example, as acrylic series latex, a homopolymer or a copolymer of monomers such as acrylate or methacrylate having an alkyl group, an aryl group, an aralkyl group, a hydroxyalkyl group, etc., acrylonitrile, acrylamide, acrylic acid and methacrylic acid, or a copolymer of at least one of the above-mentioned monomer and at least one monomer selected from styrene-sulfonic acid, vinylsulfonic acid, itaconic acid, maleic acid, fumaric acid, maleic anhydride, vinyl isocyanate, allyl isocyanate, vinyl methyl ether, vinyl acetate, styrene, divinylbenzene, etc. As an olefinic series latex, a polymer comprising a copolymer of vinyl monomer and diolefin, and as the vinyl monomer, styrene, acrylonitrile, methacrylonitrile, methyl acrylate, methyl methacrylate, vinyl acetate, etc. are preferably used, and as the diolefin, butadiene, isoprene, chloroprene, etc. are preferably used.

In the ink-receptive layer of the present invention, the organic binder is preferably used in an amount of 5 to 35% by weight, particularly preferably in the range of 10 to 30% by weight, further preferably 10 to 27% by weight based on the amount of the inorganic fine particles. Thus, by lowering a ratio of the organic binder, an ink-absorption property is improved.

A preferred range of a ratio of the organic binder in the ink-receptive layer is optionally selected depending on the kind of the inorganic fine particles to be used. When fumed silica is used in the ink-receptive layer, a ratio of the organic binder is preferably in the range of 15 to 30% by weight, more preferably in the range of 16 to 27% by weight, particularly preferably in the range of 17 to 25% by weight based on the amount of fumed silica. When the wet process silica is used in the ink-receptive layer, a ratio of the organic binder is preferably within the range of 10 to 20% by weight, particularly preferably within the range of 12 to 19% by weight based on the amount of the wet process silica.

In the present invention, various kinds of oil droplets may be added to the ink-receptive layer to improve strength of a film. As such oil droplets, there may be mentioned a hydrophobic organic solvent having a high boiling (for example, liquid paraffin, dioctyl phthalate, tricresyl phosphate, silicone oil, etc.) or polymer particles (for example, particles in which at least one of a polymerizable monomer such as styrene, butyl acrylate, divinyl benzene, butyl methacrylate, hydroxyethyl methacrylate, etc. is/are polymerized) each having a solubility in water at room temperature of 0.01% by weight or less. Such oil droplets can be used in an amount in the range of 10 to 50% by weight based on the amount of the organic binder.

In the present invention, a film hardener is preferably contained in the ink-receptive layer in addition to the organic binder. Specific examples of the film hardener may include an aldehyde type compound such formaldehyde and glutaraldehyde; a ketone compound such as diacetyl and chloropentanedione; bis(2-chloroethylurea), 2-hydroxy-4,6-dichloro-1,3,5-triazine, a compound having a reactive halogen as disclosed in U.S. Pat. No. 3,288,775; divinylsulfone; a compound having a reactive olefin as disclosed in U.S. Pat. No. 3,635,718; a N-methylol compound as disclosed in U.S. Pat. No. 2,732,316; an isocyanate compound as disclosed in U.S. Pat. No. 3,103,437; an aziridine compound as disclosed in U.S. Pat. No. 3,017,280 and No. 2,983,611; a carbodiimide type compound as disclosed in U.S. Pat. No. 3,100,704; an epoxy compound as disclosed in U.S. Pat. No. 3,091,537; a halogen carboxyaldehyde compound such as mucochloric acid, a dioxane derivative such as dihydroxydioxane, an inorganic film hardener such as chromium alum, zirconium sulfate, boric acid and a borate, and they may be used independently or in combination of two or more. Of these, boric acid and a borate are particularly preferred. An amount of the film hardener to be added is preferably 0.1 to 40% by weight, more preferably 0.5 to 30% by weight based on the amount of the organic binder constituting the ink-receptive layer.

To the ink-receptive layer, various kinds of conventionally known additives such as a coloring dye, a coloring pigment, a fixing agent of an ink dye, an UV absorber, an antioxidant, a dispersant of the pigment, an antifoaming agent, a leveling agent, an antiseptic agent, a fluorescent brightener, a viscosity stabilizer, a pH buffer, etc. may be added. Also, a pH of the coating solution of the ink-receptive layer of the present invention is preferably within the range of 3.3 to 6.0, particularly preferably in the range of 3.5 to 5.5.

The ink-jet recording material of the present invention has a layer mainly containing colloidal silica (hereinafter referred to as “colloidal silica-containing layer”) on the above-mentioned ink-receptive layer. This colloidal silica-containing layer is preferably a layer at an uppermost surface (an outermost layer). Moreover, the colloidal silica-containing layer is preferably adjacent to the above-mentioned ink-receptive layer.

The colloidal silica-containing layer is a layer containing cationic colloidal silica as the colloidal silica, or a layer containing a cationic compound irrespective of the kind of the colloidal silica. The colloidal silica to be used in the present invention belongs to the wet process silica as mentioned above, and is silica synthesized by the sol method. Specifically it is prepared by dispersing silicon dioxide obtained by metathesis of sodium silicate by an acid or heating and ripening silica sol obtained by passing through an ion exchange resin layer in water in a colloidal state, and is a wet method synthetic silica having an average primary particle size of several nm to 100 nm or so.

As colloidal silica, SNOWTEX ST-20, ST-30, ST-40, ST-C, ST-N, ST-20L, ST-O, ST-OL, ST-S, ST-XS, ST-XL, ST-YL, ST-ZL, ST-OZL, etc. (all trade names) are commercially available from Nissan Chemical Industries, Ltd. These colloidal silicas are generally anionic.

The cationic colloidal silica to be used in the present invention is a material obtained by, for example, reacting a polyvalent metallic ion such as an aluminum ion, magnesium ion, calcium ion, zirconium ion, etc., to the colloidal silica obtained by metathesis of sodium silicate by an acid or heating and ripening silica sol obtained by passing through an ion exchange resin layer, and in Japanese Patent Publication No. 26959/1973, a cationic colloidal silica treated by aluminum is disclosed. As commercially available cationic colloidal silica, there are SNOWTEX ST-AK-L, ST-UP-AK, ST-AK, ST-PS-M-AK, ST-AK-YL, etc. (all trade names) available from Nissan Chemical Industries, Ltd.

As the colloidal silica to be used in the present invention, in the viewpoints of ink-absorption property and glossiness, those having an average primary particle size in the range of 10 to 100 nm are preferred, in particular, those having a size in the range of 30 to 100 nm are more preferred. Moreover, two or more kinds of colloidal silica having different average primary particle size may be used in combination. In this case, it is more preferred to use colloidal silica having an average primary particle size of 30 nm or more to less than 60 nm and colloidal silica having an average primary particle size of 60 nm or more to 100 nm or less in combination. Also, when the spherical particles are connected to form a chain state, those having an average particle size of 40 to 200 nm, preferably of 40 to 160 nm or so may be used.

The colloidal silica-containing layer contains mainly colloidal silica. Here, the terms “mainly contains colloidal silica” mean that the colloidal silica is contained in an amount of 60% by weight or more, preferably 70% by weight or more, further preferably 80% by weight or more based on the total solid content of the colloidal silica-containing layer.

A coating amount of a solid component of the colloidal silica in the colloidal silica-containing layer is preferably in the range of 0.1 to 8.0 g/m², more preferably in the range of 0.3 to 5.0 g/m², particularly preferably in the range of 0.5 to 3.0 g/m². By doing so, glossiness and flaw resistance can be more improved without lowering ink-absorption property of the ink-receptive layer.

In the present invention, the colloidal silica-containing layer is a layer containing a cationic colloidal silica as colloidal silica, or a layer containing a cationic compound irrespective of the kinds of the colloidal silica. In the former case, the above-mentioned cationic colloidal silica is mainly contained. In the latter case, the kind of the colloidal silica is not limited, and it is preferably applied to particularly when the anionic colloidal silica is used. Also, a cationic compound may be added to the former layer mainly containing the cationic colloidal silica.

As the cationic compound to be used in the latter case, the cationic compound to be used for cationizing the above-mentioned anionic inorganic fine particles can be used. Of these cationic compounds, a cationic polymer and a water-soluble polyvalent metal compound are preferably used, in particular, a cationic polymer is more preferably used. An amount of the cationic compound to be added is preferably 0.1 to 10% by weight, more preferably 0.5 to 8.0% by weight, particularly preferably 0.5 to 3% by weight based on the amount of the colloidal silica.

When the colloidal silica-containing layer contains the anionic colloidal silica and the cationic compound, it is preferred to previously mix the anionic colloidal silica and the cationic compound before adding an organic binder such as polyvinyl alcohol, etc., and to sufficiently disperse them by a stirrer having a relatively higher rotation rate, for example, a high speed homomixer or a high rotation disper.

In the colloidal silica-containing layer, an organic binder is further preferably contained. The organic binder is preferably used in an amount of 10% by weight or less, particularly preferably 8% by weight or less based on the amount of the colloidal silica, and the lower limit thereof is 0.5% by weight or so. More preferably, the organic binder is used in the range of 1 to 7% by weight based on the amount of the colloidal silica. By adding the organic binder within the range as mentioned above, flaw resistance can be improved without lowering ink-absorption property.

As the above-mentioned organic binder, the organic binder to by used in the ink-receptive layer as mentioned above may be mentioned. Of these, particularly preferred organic binder is a completely or partially saponified polyvinyl alcohol or a cation-modified polyvinyl alcohol. Among the polyvinyl alcohols, particularly preferred is a completely or partially saponified one with a saponification degree of 80% or more. The polyvinyl alcohol is preferably that having an average polymerization degree of 500 to 5000.

Also, as the cation-modified polyvinyl alcohol, there may be mentioned a polyvinyl alcohol having a primary to tertiary amino group or a quaternary ammonium group at the main chain or side chain thereof as disclosed in, for example, Japanese Provisional Patent Publication No. 10483/1986.

To the colloidal silica-containing layer, a film hardener may be used in combination with an organic binder. As the film hardener, the film hardener to be used in the ink-receptive layer as mentioned above may be mentioned. Of these film hardeners, boric acid or a borate is particularly preferably used. In the colloidal silica-containing layer, various kinds of conventionally known additives such as a surfactant, a coloring dye, a coloring pigment, an UV absorber, an antioxidant, a dispersant of the pigment, an antifoaming agent, a leveling agent, an antiseptic agent, a fluorescent brightener, a viscosity stabilizer, a pH controller, etc. may be further contained.

In the present invention, a pH of the coating solution for the colloidal silica-containing layer is preferably within the range of 3.3 to 6.0, more preferably within the range of 3.5 to 5.5.

By laminating the ink-receptive layer mainly containing the above-mentioned cationized anionic inorganic fine particles, and the colloidal silica-containing layer, flaw resistance, glossiness and ink-absorption property are improved, and no aggregation at the interface between the ink-receptive layer and the colloidal silica-containing layer occurs, so that coating unevenness or gloss unevenness is canceled.

In the present invention, a coating method of the ink-receptive layer and the colloidal silica-containing layer may be a stepwise coating method in which the layers are formed one by one (for example, using a blade coater, an air knife coater, a roll coater, a bar coater, a gravue coater, a reverse coater, etc.), or a simultaneous multilayer coating method (for example, a slide bead coater or a slide curtain coater, etc.), and the effects of the present invention can be obtained by either of the methods. However, the simultaneous multilayer coating method is preferably used.

It has generally been carried out to coat the ink-receptive layer and the colloidal silica-containing layer stepwisely (a method in which after coating and drying the ink-receptive layer, the colloidal silica-containing layer is coated and dried), but when the stepwise coating is carried out with a coated amount of the colloidal silica in the colloidal silica-containing layer of 5 g/m² or less in a solid content, and further with 3 g/m² or less, effects for glossiness and flaw resistance of the colloidal silica-containing layer cannot sufficiently be shown in some cases. This is considered by the reason that when a colloidal silica-containing layer with a thin layer is coated on a coated and dried ink-receptive layer, part of a coating solution for forming the colloidal silica-containing layer is impregnated into voids of the ink-receptive layer, so that a uniform colloidal silica-containing layer cannot be formed. Also, air existing in voids in the ink-receptive layer diffuses in the coating solution for forming the colloidal silica-containing layer as an upper layer to cause bubbles, whereby a crater state coating defect (a crater state cissing) is generated which is one of hindrances to form a uniform coating of the colloidal silica-containing layer.

Also, when fumed silica or wet process silica which is dispersed or pulverized until its average particle size becomes 500 nm or less is used as inorganic fine particles of the ink-receptive layer, and when the ink-receptive layer is once coated and dried, and then, the colloidal silica-containing layer is coated, fine cracks sometimes occur in the ink-receptive layer in the course of drying the ink-receptive layer when it is in a wet state again.

As mentioned above, the problem occurred in the case where the colloidal silica-containing layer with a thin layer is coated stepwisely on the ink-receptive layer after coating and drying can be resolved by subjecting the ink-receptive layer and the colloidal silica-containing layer to simultaneous multilayer coating. However, even when an ink-receptive layer and a colloidal silica-containing layer which have been conventionally known in the art are simply subjected to simultaneous multilayer coating, effects aimed by the present invention cannot sufficiently been obtained, and the effects can be firstly obtained by employing the constitution of the present invention.

In the present invention, coating of the colloidal silica-containing layer withathin layer is preferred in the point of obtaining good ink-absorption property. Colloidal silica is inferior in ink-absorption property, so that when the colloidal silica-containing layer is provided as an upper layer, it is preferably a thin layer. On the other hand, colloidal silica is excellent in glossiness and flaw resistance, and when a uniform coating surface can be formed, effects of sufficiently high glossiness and flaw resistance can be obtained even if it is a thin layer. Accordingly, to satisfy all the ink-absorption property, glossiness and flaw resistance simultaneously with high levels, it is particularly preferred that the colloidal silica-containing layer with a thin layer is subjected to simultaneous multilayer coating with the ink-receptive layer. To obtain these effects, the constitution of the present invention is essential.

In the present invention, the ink-receptive layer may be a single layer or may be constituted by a plural number of layers. When the ink-receptive layer comprises a plural number of layers, it is preferably provided an ink-receptive layer (A) containing wet process silica which is cationized and an average particle size of which is pulverized to 500 nm or less and an ink-receptive layer (B) containing fumed silica which is cationized and an average particle size of which is pulverized to 500 nm or less in this order. Moreover, when the above is specifically explained, a solid content of the wet process silica to be coated in the ink-receptive layer (A) is preferably 15 to 25 g/m², a solid content of the fumed silica to be coated in the ink-receptive layer (B) is preferably 1 to 8 g/m², and a solid content of the colloidal silica in the colloidal silica-containing layer (C) to be provided thereon is preferably within the range of 0.5 to 3 g/m².

As a support to be used in the present invention, there may be preferably used a water-resistant plastic resin film such as a polyester resin including polyethylene terephthalate, a diacetate resin, a triacetate resin, an acrylic resin, a polycarbonate resin, polyvinyl chloride, a polyimide resin, cellophane, celluloid, etc., and a water-resistant support such as a laminated product of paper and a resin film, a polyolefin resin-coated paper in which polyolefin resin layers are covered on both surfaces of the base paper, etc. A thickness of these water-resistant support is preferably 50 to 300 μm, more preferably 80 to 260 μm.

The polyolefin resin-coated paper a support (hereinafter referred to as a polyolefin resin-coated paper) to be preferably used in the present invention is explained in detail. A water content of the polyolefin resin-coated paper to be used in the present invention is not specifically limited, and preferably within the range of 5.0 to 9.0% in view of curling property, more preferably within the range of 6.0 to 9.0%. The water content of the polyolefin resin-coated paper can be measured by using an optional water content measurement method. For example, an infrared moisture meter, absolute dry weight method, dielectric constant method, Curl Fisher method, etc. may be used.

A base paper constituting the polyolefin resin-coated paper is not specifically limited, and any paper generally used may be used, more preferably, a smooth paper, for example, those used for a support for photography is preferably used. As a pulp constituting the base paper, natural pulp, regenerated pulp, synthetic pulp, and the like are used singly or in combination of two or more in admixture. In the base paper, an additive such as a surface sizing agent, a surface strengthening additive of paper, a filler, an antistatic agent, a fluorescent brightener, a dye, etc., may be formulated.

Moreover, a surface sizing agent, a surface strengthening additive of paper, a fluorescent brightener, an antistatic agent, a dye, an anchoring agent, etc. may be coated on the surface of the sheet.

Also, a thickness of the base paper is not particularly limited, and preferably that having a good surface smoothness prepared by compressing paper during paper-making or after paper-making by applying pressure using a calender, etc. A basis weight thereof is preferably 30 to 250 g/m².

As a polyolefin resin for coating the base paper, there may be mentioned a homopolymer of an olefin such as low density polyethylene, high density polyethylene, polypropylene, polybutene, polypentene, etc.; a copolymer comprising two or more olefins such as an ethylene-propylene copolymer, etc.; or a mixture thereof, and these polymers having various densities and melt viscosity indexes (melt index) may be used singly or in combination of two or more.

Also, to the resin of the polyolefin resin-coated paper, various kinds of additives including a white pigment such as titanium oxide, zinc oxide, talc, calcium carbonate, etc.; an aliphatic amide such as stearic amide, arachidamide, etc.; an aliphatic metal salt such as zinc stearate, calcium stearate, aluminum stearate, magnesium stearate, etc.; an antioxidant such as Irganox 1010, Irganox 1076 (both trade names, available from Ciba Geigy AG), etc.; a blue-color pigment or dye such as cobalt blue, ultramarine blue, cecilian blue, phthalocyanine blue, etc.; a magenta-color pigment or dye such as cobalt violet, fast violet, manganese violet, etc.; a fluorescent brightener, an UV absorber, etc. may be preferably added alone or optionally combining two or more.

As a mail producing method of the polyolefin resin-coated paper, the so-called extrusion coating method in which a polyolefin resin is flown in a melted state under heating on a running base paper is generally employed, and both surfaces of the base paper are coated by a resin. Also, before coating the resin on the base paper, an activation treatment such as corona discharging treatment, flame treatment, etc., is preferably applied to the base paper. As a thickness of the resin coated layer, it is suitably 5 to 50 μm.

At the side of the water-resistant support on which an ink-receptive layer is provided by coating to be used in the present invention, a subbing layer may be preferably provided. This subbing layer is previously provided on the surface of the water-resistant support by coating and drying before the ink-receptive layer is provided by coating. This subbing layer comprises a film-formable water-soluble polymer or polymer latex, etc. as a main component. The subbing layer more preferably comprises a water-soluble polymer such as gelatin, polyvinyl alcohol, polyvinyl pyrrolidone, water-soluble cellulose, etc., particularly preferably gelatin. An amount to be attached of the water-soluble polymer to the surface of the water-resistant support is preferably 10 to 500 mg/m², more preferably 20 to 300 mg/m². Moreover, the subbing layer may further contain a surfactant, a film hardener, etc. By providing the subbing layer to the support, it effectively acts to prevent from cracking at the time of coating the before coating the ink-receptive layer whereby a uniform coated surface can be obtained.

### EXAMPLE

In the following, the present invention is explained in more detail by referring to Example, but the contents of the present invention are not limited by Examples.

### Example 1

<Preparation of Polyolefin Resin-Coated Paper>

A mixture of a bleached craft pulp of hardwood (LBKP) and a bleached sulfite pulp of softwood (LBSP) in amounts of 1:1 was subjected to beating until it becomes 300 ml with a Canadian Standard Freeness to prepare a pulp slurry. To the slurry were added 0.5% by weight of an alkylketene dimer based on the pulp as a sizing agent, 1.0% by weight of a polyacrylamide based on the pulp as a strengthening additive of paper, 2.0% by weight of a cationized starch based on the pulp, and 0.5% by weight of a polyamide epichlorohydrin resin based on the pulp, and the resulting slurry was diluted by water to make 1% of a slurry. Paper was prepared from the slurry by using a wire paper machine with a basis weight of 170 g/m² with drying and moisture adjustment to prepare a base paper for a polyolefin resin-coated paper. The base paper thus prepared was subjected to extrusion coating by a polyethylene resin composition in which 10% by weight of an anatase type titanium oxide had been uniformly dispersed in 100% by weight of a low density polyethylene with a density of 0.918 g/cm³ and melted at 320° C., with the conditions of 200 m/min so as to have a thickness of 35 μm, and then, subjected to extrusion coating by using cooling rolls which had been subjected to fine surface-roughing treatment to provide a resin-coated paper layer on the surface. On the other surface of the base paper, a blended resin composition comprising 70 parts by weight of a high-density polyethylene resin with a density of 0.962 g/cm³ and 30 parts by weight of a low-density polyethylene resin with a density of 0.918 g/cm³ melted at 320° C. was subjected to extrusion coating with a thickness of 30 μm to provide a resin-coated layer at the back surface.

Onto the surface of the above-mentioned polyolefin resin-coated paper was applied a high frequency corona discharge treatment, and then, a subbing layer with the following composition was coated and dried so that a gelatin amount became 50 mg/m² to prepare a support. Incidentally, “part” means “part by weight”.

<Subbing Layer>

| | | |
|---|---|---|
| Lime-treated gelatin | 100 | parts |
| Sulfosuccinic acid-2-ethyl hexyl ester salt | 2 | parts |
| Chromium alum | 10 | parts |

On the surface of the support prepared as mentioned above on which the subbing layer had been provided, an ink-receptive layer coating solution and a colloidal silica-containing layer coating solution each having the following composition were subjected to simultaneous multilayer coating by a slide bead coater. A wet coated amount of the ink-receptive layer coating solution was 220 g/m² (a solid content of the fumed silica coated was 19.8 g/m²), and a wet coated amount of the colloidal silica-containing layer coating solution was 15 g/m² (a solid content of the colloidal silica coated was 1.2 g/m²).

<Preparation of Fumed Silica Dispersion 1>

| | | |
|---|---|---|
| Water | 430 | parts |
| Modified ethanol | 22 | parts |
| Cationic polymer of polydiallylamine derivative | 3 | parts |
| (Dimethyldially ammonium chloride homopolymer | | |
| Sharol DC902P, trade name, available from Daiichi Kogyo | | |
| Seiyaku K.K., Molecular weight: 9,000) | | |
| Fumed silica | 100 | parts |
| (Average particle size: 7 nm, Specific surface area by BET | | |
| method: 300 m²/g) | | |

A cationic polymer was added to water and modified ethanol as a dispersant, and then, fumed silica was added to carry out provisional dispersion to prepare a crude dispersion. Next, this crude dispersion was treated by a high-pressure homogenizer twice to prepare a dispersion of cationized fumed silica with a silica concentration of 20% by weight. An average particle size of the fumed silica was 100 nm.

<Coating Solution for Ink-Receptive Layer A>

| | | |
|---|---|---|
| Fumed silica dispersion 1 (as a solid content of fumed | 100 | parts |
| silica) | | |
| Polyvinyl alcohol | 22 | parts |
| (saponification degree: 88%, average polymerization | | |
| degree: 3500) | | |
| Boric acid | 5 | parts |
| Surfactant | 0.3 | part |
| (Betain type; available from Nihon Surfactant Kogyo K.K., | | |
| Swanol AM, trade name) | | |

To fumed silica dispersion 1 were added polyvinyl alcohol, boric acid and a surfactant, and the resulting mixture was dispersed again by a high-pressure homogenizer to prepare an ink-receptive layer coating solution. This ink-receptive layer coating solution was so adjusted that the solid content concentration of the fumed silica of 9% by weight and a pH of 4.5.

<Preparation of Fumed Silica Dispersion 2>

| | | |
|---|---|---|
| Water | 430 | parts |
| Modified ethanol | 22 | parts |
| Fumed silica | 100 | parts |
| (Average particle size: 7 nm, Specific surface area by BET | | |
| method: 300 m²/g) | | |

Fumed silica was added to water and modified ethanol as a dispersant, and carried out provisional dispersion to prepare a crude dispersion. Next, this crude dispersion was treated by a high-pressure homogenizer twice to prepare a dispersion of cationized fumed silica with a silica concentration of 20% by weight. An average particle size of the fumed silica was 100 nm.

<Coating Solution for Ink-Receptive Layer B>

| | | |
|---|---|---|
| Fumed silica dispersion 2 (as a solid content of fumed | 100 | parts |
| silica) | | |
| Cationic polymer of polydiallylamine derivative | 3 | parts |
| (Dimethyldially ammonium chloride homopolymer | | |
| Sharol DC902P, trade name, available from Daiichi Kogyo | | |
| Seiyaku K.K., Molecular weight: 9,000) | | |
| Polyvinyl alcohol | 22 | parts |
| (saponification degree: 88%, average polymerization | | |
| degree: 3500) | | |
| Boric acid | 5 | parts |
| Surfactant | 0.3 | part |
| (Betain type; available from Nihon Surfactant Kogyo K.K., | | |
| Swanol AM, trade name) | | |

To fumed silica dispersion 2 were added a cationic polymer of a polydiallylamine derivative, polyvinyl alcohol, boric acid and a surfactant, and the resulting mixture was dispersed again by a high-pressure homogenizer to prepare an ink-receptive layer coating solution. This ink-receptive layer coating solution was so adjusted that the solid content concentration of the fumed silica of 9% by weight and a pH of 4.5.

<Coating Solution for Colloidal Silica-Containing Layer A>

| | | |
|---|---|---|
| Colloidal silica | 100 | parts |
| Combination SNOWTEX ST-OL40 having an average | | |
| primary particle size of 40 to 50 nm and SNOWTEX | | |
| ST-OZL having an average primary particle size of 70 nm | | |
| (both available from Nissan Chemical Industries, Ltd.) | | |
| (combination ratio; ST-OL40: ST-OZL = 7:3) | | |
| Cationic polymer; Polyfix 601 | 1 | part |
| (available from Showa Highpolymer Co., Ltd., specifically | | |
| modified polyamine) | | |
| Polyvinyl alcohol | 4 | parts |
| (saponification degree: 88%, average polymerization | | |
| degree: 3500) | | |
| Surfactant | 0.3 | part |
| (Betain type; available from Nihon Surfactant Kogyo K.K., | | |
| Swanol AM, trade name) | | |

The coating solution for the above-mentioned colloidal silica-containing layer A was prepared as mentioned below.

First, water was added so that a concentration of the colloidal silica became 10% by weight to prepare an aqueous colloidal silica solution, and after 0.5% by weight of an aqueous sodium hydroxide solution was added to this aqueous colloidal silica solution while stirring with a high speed with a high-speed rotation disper to raise the pH thereof about 1, a cationic polymer (10% by weight solution of Polyfix 601) was added to the mixture and the resulting mixture was furter stirred with a high speed for 10 minutes. Then, polyvinyl alcohol and a surfactant were added in this order to prepare a coating solution for a colloidal silica-containing layer A. A concentration of the colloidal silica of this coating solution was 8% by weight and a pH of the coating solution was 4.0.

<Coating Solution for Colloidal Silica-Containing Layer B>

| | | |
|---|---|---|
| Colloidal silica | 100 | parts |
| Cationic colloidal silica having an average primary parti- | | |
| cle size of 10 to 20 nm (available from Nissan Chemical | | |
| Industries, Ltd., SNOWTEX AK) and cationic colloidal | | |
| silica having an average primary particle size of 60 nm | | |
| (available from Nissan Chemical Industries, Ltd., | | |
| SNOWTEX AK-YL) were used in combination with a ratio | | |
| of 7:3 | | |
| polyvinyl alcohol | 4 | parts |
| (saponification degree: 88%, average polymerization | | |
| degree: 3500) | | |
| Surfactant | 0.3 | part |
| (Betain type; available from Nihon Surfactant Kogyo K.K., | | |
| Swanol AM, trade name) | | |

A sample was prepared based on the above compositions in the same manner as in the preparation of the colloidal silica-containing layer A except for not adding a cationic polymer.

<Coating Solution for Colloidal Silica-Containing Layer C>

The solution was prepared in the same manner as in the above-mentioned colloidal silica-containing layer A. However, a cationic polymer (Polyfix 601) was not added.

The coating solution for an ink-receptive layer and the coating solution for a colloidal silica-containing layer prepared as mentioned above were subjected to simultaneous multilayer coating by a slide bead coating device to prepare six kinds of ink-jet recording materials shown in Table 1. Drying conditions after coating were cooling with an atmosphere of 10° C. or less immediately after coating whereby gelling the material, and then, drying with a warm wind of 30 to 50° C. With regard to the thus prepared six kinds of recording materials, ink-absorption property, glossiness and flaw resistance were evaluated by the following methods, respectively. Moreover, a degree of occurrence of unevenness at the coating surface was evaluated. The results are shown in Table 1.

<Ink-Absorption Property>

By using an ink-jet printer PM-880C available from Seiko Epson Corporation, printing was carried out with a mixed color of Y, M and C, and an absorption state of ink and occurrence of mottling (unevenness in shading of an image) were observed with naked eyes and evaluated according to the following standard.

⊚: Ink was rapidly absorbed and no occurrence of mottling.

∘: Absorption of ink was slightly slow but no occurrence of mottling.

Δ: Ink was slightly overflown at the printed surface and occurrence of mottling was slightly admitted.

×: Ink was overflown at the printed surface and occurrence of strong mottling could be clearly admitted.

<Glossiness>

Glossiness of the recording material before printing was observed with slant light and evaluated according to the following standard.

∘: High glossiness like color photograph can be admitted.

Δ: Glossiness like art or coated paper can be admitted.

×: Glossiness like art or coated paper cannot be admitted.

<Flaw Resistance>

Two sheets of the recording materials not yet printed were overlapped with the surface upside, 150 g of a weight was placed on the sheets and the recording material at the lower side was drawn out while placing the weight. Then, flaw at the surface of the ink-receptive layer of the drawn out recording material was observed with naked eyes.

∘: No flaw was admitted.

Δ: Flaw was slightly admitted.

×: Flaw was clearly admitted.

<Unevenness at the Coated Surface>

Occurrence of unevenness at the coated surface was observed with naked eyes and evaluated according to the following standard.

∘: No unevenness at the coated surface was admitted.

Δ: Unevenness at the coated surface was slightly admitted.

×: Unevenness at the coated surface was clearly admitted.

TABLE 1

| | Ink | Colloidal | Ink | | | | |
|---|---|---|---|---|---|---|---|
| Recoding | receptive | silica | absorption | | Flaw | Coating | |
| material | layer | layer | property | Glossiness | resistance | unevenness | Remarks |
| 1 | A | A | ⊚ | ◯ | ◯ | ◯ | Present |
| | | | | | | | invention |
| 2 | A | B | ◯ | ◯ | ◯ | ◯ | Present |
| | | | | | | | invention |
| 3 | A | C | X | Δ | X | X | Comparative |
| | | | | | | | example |
| 4 | B | A | ◯ | Δ | Δ | Δ | Comparative |
| | | | | | | | example |
| 5 | B | B | Δ | Δ | Δ | Δ | Comparative |
| | | | | | | | example |
| 6 | B | C | X | Δ | X | X | Comparative |
| | | | | | | | example |

### Example 2

Wet process silica was pulverized as mentioned below to prepare a wet process silica dispersion 1.

<Wet Process Silica Dispersion 1>

To a dispersing medium in which 4 g of a cationic polymer (Dimethyldiallyl ammonium chloride homopolymer; Sharol DC902P, trade name, available from Daiichi Kogyo Seiyaku K. K., Molecular weight: 9,000) was dissolved in water was added 100 parts of precipitation method silica (Nipsil VN3, trade name, available from Nippon Silica Industrial Co., Ltd., average secondary particle size: 23 μm) and dispersed by using a saw blade type dispersing machine (blade peripheral speed: 30 m/sec) to prepare a provisional dispersion. Next, this provisional dispersion was passed once through a beads mill (using zirconia beads having a diameter of 0.3 mm, filling ratio of the beads: 80% by volume, disc pheripheral speed: 10 m/sec) to prepare a wet process silica dispersion 1 having a solid content concentration of 30% by weight and an average particle size of 200 nm.

<Coating Solution for Ink-Receptive Layer C>

| | | |
|---|---|---|
| Wet process silica dispersion 1 (as a silica solid content) | 100 | parts |
| Polyvinyl alcohol | 15 | parts |
| (saponification degree: 88%, average polymerization | | |
| degree: 3500) | | |
| Boric acid | 3 | parts |

The coating solution for the ink-receptive layer C was so adjusted that a solid content concentration of the wet process silica of 15% by weight and a pH of 4.5.

<Wet Process Silica Dispersion 2>

The dispersion was prepared in the same manner as in the preparation of the wet process silica dispersion 1 except for not using the cationic polymer.

<Coating Solution for Ink-Receptive Layer D>

| | | |
|---|---|---|
| Wet process silica dispersion 2 (as a silica solid content) | 100 | parts |
| Polyvinyl alcohol | 15 | parts |
| (saponification degree: 88%, average polymerization | | |
| degree: 3500) | | |
| Cationic polymer | 4 | parts |
| (Dimethyldially ammonium chloride homopolymer | | |
| Sharol DC902P, trade name, available from Daiichi Kogyo | | |
| Seiyaku K.K., Molecular weight: 9,000) | | |
| Boric acid | 3 | parts |

The coating solution for the ink-receptive layer D was so adjusted that a solid content concentration of the wet process silica of 15% by weight and a pH of 4.5.

On the surface of the support on which the same subbing layer had been provided as in Example 1, the ink-receptive layer coating solution mentioned above and a colloidal silica-containing layer coating solution prepared in Example 1 were subjected to simultaneous multilayer coating by a slide bead coater and dried in the same manner as in Example 1 to prepare six kinds of ink-jet recording materials shown in Table 2. A wet coated amount of the ink-receptive layer coating solution was 147 g/m² (a solid content of the wet process silica coated was 22.0 g/m²), and a wet coated amount of the colloidal silica-containing layer coating solution was 15 g/m2 (a solid content of the colloidal silica coated was 1.2 g/m²).

With regard to the ink-jet recording materials prepared as mentioned above, the same evaluations as in Example 1 were carried out. The results are shown in Table 2.

TABLE 2

| | Ink | Colloidal | Ink | | | | |
|---|---|---|---|---|---|---|---|
| Recording | receptive | silica | absorption | | Flaw | Coating | |
| material | layer | layer | property | Glossiness | resistance | unevenness | Remarks |
| 7 | C | A | ⊚ | ◯ | ◯ | ◯ | Present |
| | | | | | | | invention |
| 8 | C | B | ◯ | ◯ | ◯ | ◯ | Present |
| | | | | | | | invention |
| 9 | C | C | X | Δ | X | X | Comparative |
| | | | | | | | example |
| 10 | D | A | ◯ | Δ | Δ | Δ | Comparative |
| | | | | | | | example |
| 11 | D | B | Δ | Δ | Δ | Δ | Comparative |
| | | | | | | | example |
| 12 | D | C | X | Δ | X | X | Comparative |
| | | | | | | | example |

### Example 3

On the surface of the support on which the same subbing layer had been provided as in Example 1, the coating solution for the ink-receptive layer C prepared in Example 2, the coating solution for the ink-receptive layer A prepared in Example 1 and a colloidal silica-containing layer coating solution prepared in Example 1 were subjected to simultaneous multilayer coating in this order by a slide bead coater and dried in the same manner as in Example 1 to prepare two kinds of ink-jet recording materials shown in Table 3. A wet coated amount of the coating solution for the ink-receptive layer C was 133 g/m² (a solid content of the wet process silica coated was 20.0 g/m²), a wet coated amount of the coating solution for the ink-receptive layer A was 44 g/m2 (a solid content of the fumed silica coated was 4.0 g/m²) and a wet coated amount of the colloidal silica-containing layer coating solution was 15 g/m² (a solid content of the colloidal silica coated was 1.2 g/m²)

With regard to the ink-jet recording materials prepared as mentioned above, the same evaluations as in Example 1 were carried out. The results are shown in Table 3.

TABLE 3

| | Ink | Colloidal | Ink | | | | |
|---|---|---|---|---|---|---|---|
| Recording | receptive | silica | absorption | | Flaw | Coating | |
| material | layer | layer | property | Glossiness | resistance | unevenness | Remarks |
| 13 | C + A | A | ⊚ | ◯ | ◯ | ◯ | Present |
| | | | | | | | invention |
| 14 | C + A | B | ⊚ | ◯ | ◯ | ◯ | Present |
| | | | | | | | invention |

From the results shown above, it can be understood that the recording materials of the present invention are excellent in all the characteristics of ink-absorption property, glossiness, flaw resistance and coating unevenness.

1. An ink-jet recording material which comprises a support, at least one ink-receptive layer mainly containing cationized anionic inorganic particles and a layer mainly containing colloidal silica both of which are provided on the support in this order, wherein the colloidal silica-containing layer contains cationic colloidal silica or a cationic compound.

2. The ink-jet recording material according to claim 1, wherein the cationized anionic inorganic particles are particles in which synthetic silica is dispersed in a dispersing medium mainly comprising water in the presence of a cationic compound so that an average particle size becomes 500 nm or less.

3. The ink-jet recording material according to claim 1, wherein the cationized anionic inorganic particles are particles in which synthetic silica is dispersed in a dispersing medium mainly comprising water in the presence of a cationic compound so that an average particle size becomes 300 nm or less.

4. The ink-jet recording material according to claim 1, wherein the cationized anionic inorganic particles are fumed silica.

5. The ink-jet recording material according to claim 1, wherein the cationized anionic inorganic particles are wet process silica.

6. The ink-jet recording material according to claim 1, wherein the cationized anionic inorganic particles are precipitation method silica or gel method silica.

7. The ink-jet recording material according to claim 1, wherein the cationized anionic inorganic particles are precipitation method silica.

8. The ink-jet recording material according to claim 2, wherein the cationic compound is a cationic polymer, a water-soluble polyvalent metal compound or a silane coupling agent.

9. The ink-jet recording material according to claim 2, wherein the cationic compound is a cationic polymer or a water-soluble polyvalent metal compound.

10. The ink-jet recording material according to claim 2, wherein the cationic compound is a cationic polymer.

11. The ink-jet recording material according to claim 2, wherein the cationic compound is a cationic polymer having a weight average molecular weight of 50,000 or less.

12. The ink-jet recording material according to claim 2, wherein the cationic compound is a cationic polymer having a constitutional unit of a polydiallylamine compound.

13. The ink-jet recording material according to claim 1, wherein the colloidal silica-containing layer is a layer mainly containing cationic colloidal silica.

14. The ink-jet recording material according to claim 1, wherein the colloidal silica-containing layer is a layer mainly containing anionic colloidal silica and further containing a cationic compound.

15. The ink-jet recording material according to claim 1, wherein the cationic compound in the colloidal silica-containing layer is a cationic polymer or a water-soluble polyvalent metal compound.

16. The ink-jet recording material according to claim 1, wherein the ink-receptive layer contains 5 to 35% by weight of an organic binder based on the amount of the inorganic particles.

17. The ink-jet recording material according to claim 1, wherein the colloidal silica-containing layer contains 1 to 7% by weight of an organic binder based on the amount of the colloidal silica.

18. The ink-jet recording material according to claim 1, wherein a solid content coated amount of the cationized anionic inorganic particles is 10 to 35 g/m², and a solid content coated amount of the colloidal silica is 0.3 to 5.0 g/m².

19. The ink-jet recording material according to claim 1, wherein the ink-receptive layer is constituted by at least two layers of (A) an ink-receptive layer containing wet process silica which is cationized and pulverized to have an average particle size of 500 nm or less and (B) an ink-receptive layer containing fumed silica which is cationized and pulverized to have an average particle size of 500 nm or less.

20. The ink-jet recording material according to claim 1, wherein the material is prepared by simultaneous multiple layer coating of the ink-receptive layer and the colloidal silica-containing layer.
